(19) United States
(12) Patent Application Publication
(10) Pub. No.: US 2015/0138459 A1
(43) Pub. Date: May 21, 2015

(54) STEREOSCOPIC IMAGE DISPLAY

(71) Applicant: KABUSHIKI KAISHA TOSHIBA, Tokyo (JP)

(72) Inventors: Tomoya TSURUYAMA, Kawasaki (JP); Norihiro Nakamura, Kawasaki (JP); Yasunori Taguchi, Kawasaki (JP)

(73) Assignee: KABUSHIKI KAISHA TOSHIBA

(21) Appl. No.: 14/519,437

(22) Filed: Oct. 21, 2014

(30) Foreign Application Priority Data
Nov. 20, 2013 (JP) 2013-240009

(51) Int. Cl. G02B 27/22; G02B 27/26

(52) U.S. Cl. CPC G02B 27/2214; G02B 27/26
USPC 349/15; 359/463

(57) ABSTRACT

A stereoscopic image display includes a first display, a second display, a first optical element, and a second optical element. The first display includes pixels arranged therein. The second display includes pixels arranged in horizontal and vertical directions and is disposed on the first display. The first optical element is provided between the first display and the second display, and includes lenses extending in a direction inclined with respect to the horizontal or vertical direction of the second display. The second optical element is provided between the first display and the first optical element, and transmits a light polarized in first direction of a light transmitted from the first optical element.

### CROSS-REFERENCE TO RELATED APPLICATION(S)

This application is based upon and claims the benefit of priority from Japanese Patent Application No. 2013-240009, filed on Nov. 20, 2013; the entire contents of which are incorporated herein by reference.

### FIELD

Embodiments described herein relate generally to a stereoscopic image display.

### BACKGROUND

The following types of displays are known: a display configured using the depth-fused 3D (DFD) technique in which a plurality of display panels is laminated and in which a three-dimensional image is displayed by displaying a two-dimensional image on each display panel; and a display (a contents-application-type glasses-free stereoscopic display) in which the luminance values of the pixels in each layer are optimized to bring them closest to the ray space of the three-dimensional image to be displayed.

In such displays, depending on the periodicity of the arrangement of optical apertures (i.e., apertures for transmitting light) in each display panel, sometimes there occurs interference in the exiting light thereby resulting in the occurrence of light and dark bands called moire.

In order to reduce the occurrence of moire; for example, a technology is known in which diffuser panels, which diffuse light, or optical elements (such as prisms or lenticular lenses), which branch the incident light into a plurality of light paths, are disposed in between the panels.

However, in the conventional technology, because of the optical elements disposed for the purpose of reducing the occurrence of moire, the polarization state undergoes a change. Hence, there occurs unevenness (non-uniformity) in the luminance of the stereoscopic image being viewed. As a result, the image quality of the stereoscopic image being viewed undergoes a decline.

### BRIEF DESCRIPTION OF THE DRAWINGS

FIG. 1 is a diagram illustrating a stereoscopic image display according to an embodiment;

FIG. 2 is a diagram illustrating a cross-sectional surface of a liquid crystal display according to the embodiment; and

FIG. 3 is a diagram illustrating the stereoscopic image display according to a modification example;

FIG. 4 is a diagram illustrating the stereoscopic image display according to a modification example; and

FIG. 5 is a diagram illustrating the stereoscopic image display according to a modification example.

### DETAILED DESCRIPTION

A stereoscopic image display includes a first display, a second display, a first optical element, and a second optical element. The first display includes pixels arranged therein. The second display includes pixels arranged in horizontal and vertical directions and is disposed on the first display. The first optical element is provided between the first display and the second display, and includes lenses extending in a direction inclined with respect to the horizontal or vertical direction of the second display. The second optical element is provided between the first display and the first optical element, and transmits a light polarized in first direction of a light transmitted from the first optical element.

An embodiment of a stereoscopic image display is described below in detail with reference to the accompanying drawings. In the stereoscopic image display according to the embodiment, a plurality of (at least two) displays, each of which has a plurality pixels arranged therein, is arranged in a laminated manner; and a stereoscopic image is displayed by displaying a two-dimensional image on each display. Herein, a stereoscopic image points to an image that includes a plurality of images having mutually different parallaxes. Moreover, a parallax points to the difference in vision when seen from a different direction. Furthermore, an image can either be a still image or a dynamic picture image. Moreover, a pixel represents the smallest unit that has color information (such as hue or gradation).

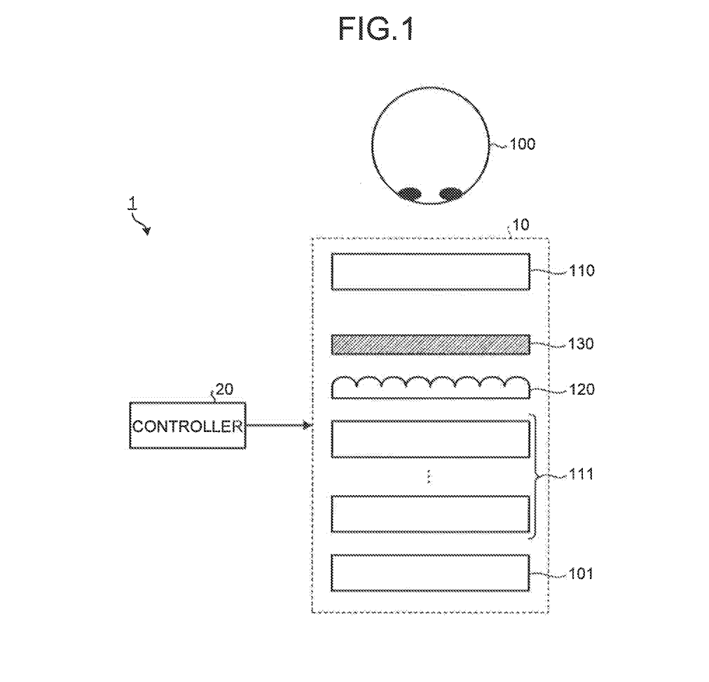

FIG. 1 is a diagram illustrating a stereoscopic image display 1 according to the embodiment. As illustrated in FIG. 1, the stereoscopic image display 1 includes a display 10 and a controller 20.

The display 10 includes a plurality of displays arranged in a laminated manner, and the luminance values of the pixels in each display are optimized to bring them closest to the ray space of the stereoscopic image to be displayed. Regarding the method of optimizing the luminance values of the pixels in each display, it is possible to implement, for example, the method disclosed in Pub No. US-A1 2012/0140131.

As illustrated in FIG. 1, the display 10 includes a first display 110, a second optical element 130, a first optical element 120, a display group 111, and a light source 101. In the example illustrated in FIG. 1, the first display 110, the second optical element 130, the first optical element 120, the display group 111, and the light source 101 are arranged in that order from the closest position to a viewer 100.

In the example illustrated in FIG. 1, the display group 111 includes a plurality of displays arranged in a mutually-overlapping manner (i.e., arranged in a laminated manner). However, that is not the only possible case. Alternatively, the display group 111 may include only a single display. Herein, of a plurality of displays included in the display group 111, the display placed at the closest position to the viewer 100 is considered to correspond to a “second display” mentioned in claims. Thus, in the following explanation, that display is sometimes referred to as the “second display”.

Moreover, in the example illustrated in FIG. 1, of a plurality of displays included in the display group 111, a display other than the second display is considered to correspond to a “third display” mentioned in claims. Thus, in the following explanation, of a plurality of displays included in the display group 111, a display other than the second display is sometimes referred to as the “third display”. Furthermore, in the example illustrated in FIG. 1, the first display 110 that is disposed in an overlapping manner with respect to each of a plurality of displays included in the display group 111 (i.e., with respect to the second display and the third displays) is considered to correspond to a “first display” mentioned in claims. Herein, the first display 110 is disposed at the closest position to the viewer 100; and no third display is provided between the first display 110 and the second display.

The first display 110 as well as each of a plurality of displays included in the display group 111 has a plurality of pixels arranged therein. In the embodiment, the explanation is given for an example in which the first display 110 as well as each of a plurality of displays included in the display group 111 is configured with two transparent substrates, which are positioned opposite to each other, and a liquid crystal display (a liquid crystal panel), which is sandwiched between the two transparent substrates and which includes a liquid crystal layer. However, that is not the only possible configuration.

For example, if the liquid crystal display is configured using an active matrix liquid crystal display; then, on one of the transparent substrates (in the following explanation, sometimes referred to as a “first transparent substrate”), a plurality of transparent electrodes (in the following explanation, sometimes referred to as “pixel electrodes”) is formed in a matrix-like manner (in rows and columns) and with a one-to-one correspondence with a plurality of pixels. Moreover, of the other transparent substrate (in the following explanation, referred to as a “second transparent substrate”), on the face on the side opposite to the first transparent substrate, a transparent electrode (in the following explanation, sometimes referred to as a “common electrode”) is formed over the entire face. Herein, a transparent substrate can be configured with, for example, glass; and a transparent electrode can be configured with, for example, indium tin oxide (ITO).

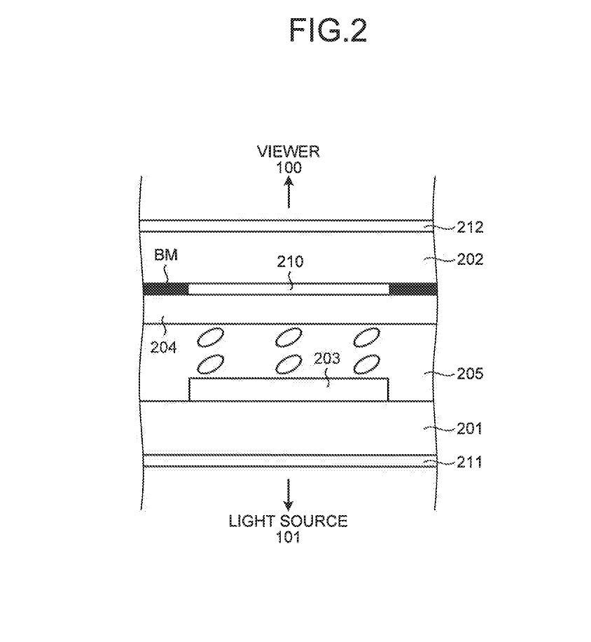

FIG. 2 is a diagram illustrating an example of a cross-sectional surface corresponding to one of the pixels of a liquid crystal display of the active matrix type. In the example illustrated in FIG. 2, the first transparent substrate is illustrated using a reference numeral 201, the second transparent substrate is illustrated using a reference numeral 202, a pixel electrode is illustrated using a reference numeral 203, the common electrode is illustrated using a reference numeral 204, and the liquid crystal layer is illustrated using a reference numeral 205. Moreover, in the example illustrated in FIG. 2, from the viewer 100, the second transparent substrate 202 is placed at a closer position as compared to the first transparent substrate 201. Of the first transparent substrate 201, on the face on the side opposite to the second transparent substrate 202, the following components are formed in addition to the pixel electrodes: a transistor (such as a thin film transistor (TFT)) that is used in controlling the difference in the electric potentials between the pixel electrode 203 and the common electrode 204; and hard-wiring. However, those components are not illustrated in FIG. 2. Regarding the light that passes through the first transparent substrate 201 and travels toward the second transparent substrate 202; the percentage (the light transmission rate) of that light passing through the liquid crystal layer 205, which is present in between the pixel electrode 203 and the common electrode 204, changes according to the difference in the electric potentials between the pixel electrode 203 and the common electrode 204.

Of the second transparent substrate 202, on the face on the side opposite to the first transparent substrate 201, a black matrix BM is formed in a grid-like manner. Moreover, in the second transparent substrate 202, a plurality of areas separated by the black matrix BM (i.e., a plurality of apertures for transmitting light) correspond on a one-to-one basis to a plurality of pixel electrodes 203. In each such area is formed a color filter 210 for the purpose of transmitting the light having the wavelength corresponding to, for example, one of the red (R) color, the green (G) color, and the blue (B) color. Thus, it can be considered that the liquid crystal display includes a plurality of optical apertures (in this example, the color filters 210) arranged in a matrix-like manner.

Furthermore, in the example illustrated in FIG. 2, the direction from the display surface of the liquid crystal display (i.e., from the surface representing the area in which a plurality of pixels is arranged) toward the viewer 100 is defined as “upper”; and the direction from the display surface toward the light source 101 is defined as “lower”. In that case, the lower surface of the first transparent substrate 201 has a polarization plate 211 attached thereto. Moreover, the upper surface of the second transparent substrate 202 has a polarization plate 212 attached thereto. The polarization plate 211 polarizes the light falling from the side of the light source 101, and the polarization plate 212 polarizes the light that has passed through the liquid crystal layer 205. The directions of polarization due to the polarization plates 211 and 212 are determined according to the direction of polarization of the light that undergoes a change due to the arrangement of liquid crystal molecules in the liquid crystal layer 205. Meanwhile, the structure of the liquid crystal display is not limited to the active matrix type. Alternatively, for example, the structure of the liquid crystal display can of the passive matrix type.

Returning to the explanation with reference to FIG. 1, in this example, the liquid crystal display that constitutes the first display 110 as well as constitutes each of a plurality of displays included in the display group 111 is a transmission type liquid crystal display. As far as the light source 101 is concerned, it is possible to use a cold-cathode tube, a hot-cathode fluorescent lamp, an electro luminescence panel, a light-emitting diode, or an electrical bulb. Meanwhile, for example, the liquid crystal display can alternatively be configured with a reflective liquid crystal display. In that case, as far as the light source 101 is concerned, it is possible to make use of a reflection layer that reflects outside light such as the sunlight or the light of an indoor electrical lamp. Still alternatively, for example, the liquid crystal display can be configured with a semi-transmissive liquid crystal display that is transmissive as well as reflective in nature.

The first optical element 120 is an optical component used in controlling the occurrence of moire. Herein, the moire can be treated as the beat phenomenon between the spatial frequency of an image formed due to the light transmitted according to the periodicity of the arrangement of the optical apertures in the first display 110 and the spatial frequency of an image formed due to the light transmitted according to the periodicity of the arrangement of the optical apertures in the second display. Thus, if the light path of the light transmitted from the second display, which is positioned farther away from the viewer 100 than the first display 110, is changed in such a way that there is a decrease in the spatial frequency of the image formed due to the light transmitted according to the periodicity of the arrangement of the optical apertures in the second display (i.e., in such a way that the image becomes blurred); then it becomes possible to control the occurrence of the beat phenomenon (i.e., to control the occurrence of moire).

As described above, the first display 110 as well as the second display includes a plurality of optical apertures (in this example, the color filters 210) with a one-to-one correspondence with a plurality of pixel electrodes 203 arranged in a matrix-like manner. Thus, it is desirable that the first optical element 120 is placed so as to enable achieving reduction in the interference between the light transmitted according to the periodicity of the arrangement of the optical apertures in the first display 110 and the light transmitted according to the periodicity of the arrangement of the optical apertures in the second display. In the embodiment, the first optical element 120 that is provided between the first display 110 and the second display is configured with a lenticular lens in which lenses (cylindrical lenses) extending in the direction inclined at an angle other than 0° with respect to the horizontal or vertical direction of the second display are arranged in a periodic manner. As a result of setting the lenticular lens at a tilt, the image of a grid-like pattern formed by the black matrix BM becomes obliquely warped, thereby resulting in an anisotropic decrease in the periodicity of the optical apertures in the second display. With that, the interference with the periodicity of the optical apertures in the first display 110 is reduced, thereby leading to a reduction in the occurrence of moire. Meanwhile, in the embodiment, since the explanation is given for an example in which a convex lenticular lens is used, the periodicity of the optical apertures in the second display decreases in an anisotropic manner. In contrast, if a concave lenticular lens is used, the periodicity of the optical apertures in the second display increases in an anisotropic manner. Thus, regardless of whether a concave lenticular lens is used or a convex lenticular lens is used, the interference between the periodicity of the optical apertures in the second display and the periodicity of the optical apertures in the first display 110 is reduced. That leads to a reduction in the occurrence of moire.

The second optical element 130 is provided between the first display 110 and the first optical element 120; and, of the light transmitted from the first optical element 120, transmits the light having a first direction of polarization to the first display 110. Herein, the direction of polarization can be considered to be the direction of motion of the electrons within a two-dimensional plane orthogonal to the direction of travel of the light.

For example, in the technology disclosed in JP-A 2005-172969 (KOKAI) mentioned above, a lenticular lens is provided between two display panels (displays) arranged in a laminated manner. With that, the interference of light (the moire) caused by the periodicity of the optical apertures is reduced. However, the lenticular lens disturbs the polarization state of the light. Because of that, in relation to the viewer, the display panel that is located farther than an optical element is viewed as having unevenness (non-uniformity) in the luminance. In that regard, in the embodiment, the second optical element 130 is disposed on that side of the obliquely-set lenticular lens (the first optical element 120) which is toward the viewer 100. Thus, the direction of polarization disturbed by the lenticular lens is corrected, and the unevenness in the luminance is eliminated.

The second optical element 130 can be configured with, for example, any one of a linear-polarization plate, an elliptic-polarization plate, and a circular-polarization plate. Thus, it is desirable that, depending on the optical property of the first optical element 120, the type of polarization plate is selected to maximize the light passing toward the first display 110. For example, as is the case in the embodiment, when the first optical element 120 is made of a lenticular lens mainly causing polarization in only one direction, then it is desirable to use an elliptic-polarization plate as the second optical element 130 so that the polarization light is rotated in the longitudinal direction of the lenticular lens. As a result of using an elliptic-polarization plate, the polarization occurring due to the lenticular lens can be reduced to the minimum, and thus the changes in the luminance of the display group 111 occurring due to the lenticular lens can be reduced to the minimum.

Given below is the explanation of the controller 20 illustrated in FIG. 1. The controller 20 is a device that controls the display 10. For example, by implementing the method disclosed in Pub No. US-A1 2012/0140131, the controller 20 determines the image to be displayed on each display (the first display 110 and the displays included in the display group 111) for the purpose of displaying an arbitrary stereoscopic image. That is, regarding each of a plurality of pixels arranged in each display, the controller 20 optimizes the luminance value so that the luminance values are closest to the ray space of the stereoscopic image to be displayed. Then, the controller 20 controls the electric potential of the electrodes (the pixel electrodes 203 and the common electrode 204), and controls the driving of the light source 101 in such a way that the luminance values of the pixels in each display are equal to the optimized values. Meanwhile, in the case in which only a two-dimensional image is to be presented, the controller 20 can perform control to display that two-dimensional image in any one of a plurality of displays arranged in a laminated manner.

As described above, in the embodiment, of the lenticular lens (the first optical element 120) that is set at a tilt with the aim of reducing the occurrence of moire, on the side of the viewer 100 is disposed the second optical element 130 that corrects the direction of polarization disturbed by the lenticular lens. Hence, it becomes possible to reduce the unevenness in the luminance of the stereoscopic image being viewed. As a result, it becomes possible to enhance the image quality of the stereoscopic image being viewed.

### MODIFICATION EXAMPLES

Given below is the explanation of modification examples.

### (1) First Modification Example

As far as the first display 110 and the displays included in the display group 111 are concerned, the configuration is not limited to the liquid crystal displays. Alternatively, for example, plasma displays, field-emission displays, or organic electroluminescence (EL) displays can also be used. Of one or more displays included in the display group 111, if the displays that are separated the most from the viewer 100 are configured using self-luminous displays such as organic EL displays; then it becomes possible to eliminate the need to use the light source 101. Alternatively, if the displays are configured using semi-transmissive self-luminous displays, then it is possible to use the light source 101 in combination.

### (2) Second Modification Example

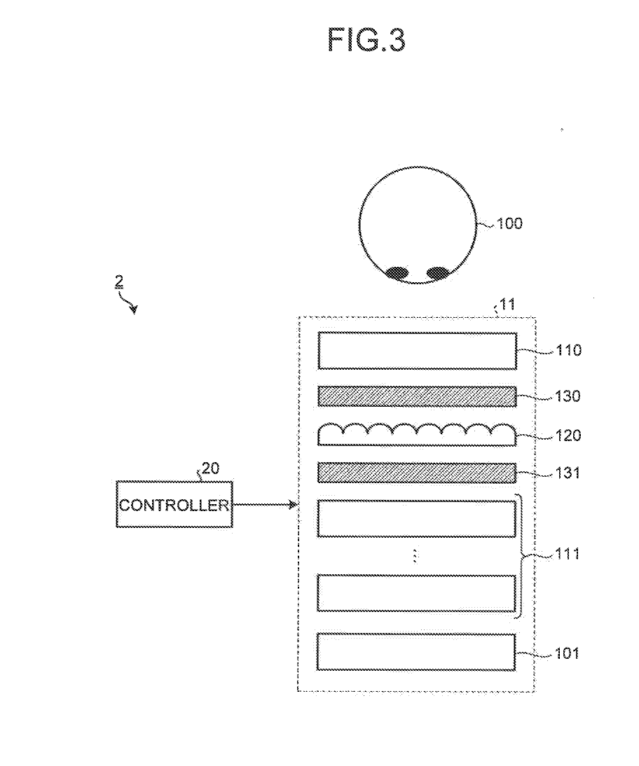

For example, as illustrated in FIG. 3, the configuration can further include a third optical element 131 that is provided between the first optical element 120 and the second display and that, of the light transmitted from the second display, transmits the light having a second direction of polarization to the first optical element 120. In the example illustrated in FIG. 3, the stereoscopic image display is referred to as a “stereoscopic image display 2”, and the display is referred to as a “display 11”.

In the embodiment described above, of the light transmitted from the second display, there is a chance that the light that should not be allowed to pass through the second optical element 130 gets modulated by the first optical element 120 into the light having the first direction of polarization and thus passes through the second optical element 130. In that regard, in the example illustrated in FIG. 3, the third optical element 131 is provided between the first optical element 120 and the second optical elements. Because of that, of the light transmitted from the second display, the light that should not be allowed to pass through the second optical element 130 is prevented in advance from exiting to the side of the first optical element 120. As a result, it becomes possible to prevent a decline in the image quality.

For example, in order to ensure that the first direction of polarization and the second direction of polarization are identical, the direction of absorption axis (or the direction of transmission axis) of each of the second optical element 130 and the third optical element 131 can be set parallel to each other. However, if the direction of polarization is changed by disposing an optical element such as a half-wavelength plate in between the second optical element 130 and the first optical element 120 or in between the third optical element 131 and the first optical element 120; then it is desirable to set the direction of absorption axis (or the direction of transmission axis) in such a way that, of the light transmitted from the third optical element 131, the light passing through the second optical element 130 via the first optical element 120 is maximized. That is, in this case, the first direction of polarization as well as the second direction of polarization is set according to the polarization property of the first optical element. More particularly, it is desirable that the first direction of polarization as well as the second direction of polarization is set in a direction in which, of the light transmitted from the third optical element 131, the light passing through the second optical element 130 via the first optical element 120 is maximized.

Meanwhile, in the example illustrated in FIG. 3, in an identical manner to the embodiment described above, the display group 111 includes a plurality of displays arranged in a mutually-overlapping manner. However, that is not the only possible case. Alternatively, the display group 111 may include only a single display.

### (3) Third Modification Example

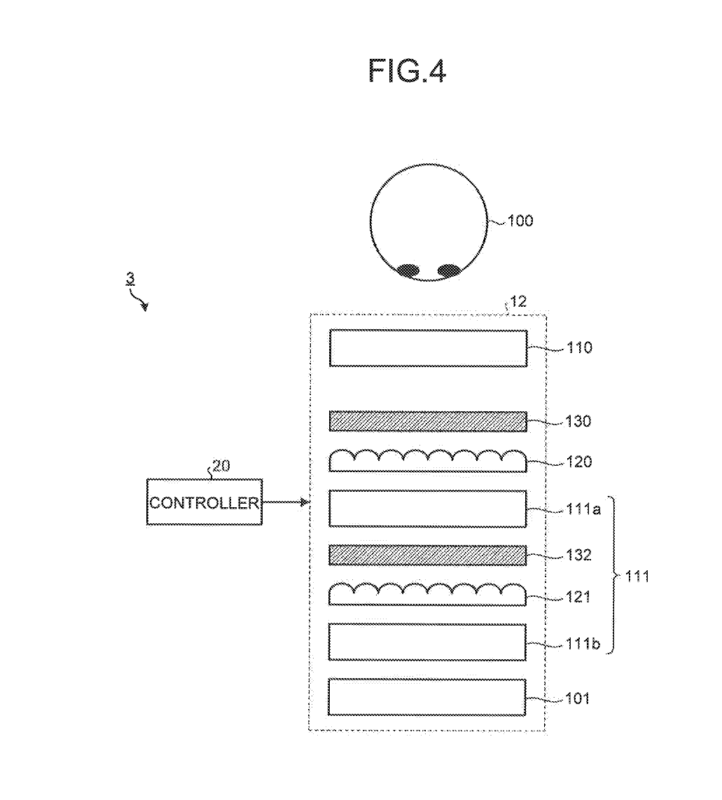

For example, the configuration can be such that a lenticular lens for reducing the occurrence of moire (i.e., a lenticular lens set at a tilt) and an optical element (typically, a polarization plate) for correcting the direction of polarization disturbed by the lenticular lens are disposed in between each pair of adjacent displays (the second display and the third displays). Herein, as illustrated in FIG. 4, the explanation is given for an example in which two displays are included in the display group 111. However, the explanation is also applicable to the case in which three or more displays are included in the display group 111. In the example illustrated in FIG. 4, the stereoscopic image display is referred to as a “stereoscopic image display 3” and the display is referred to as a “display 12”. Moreover, of the two displays included in the display group 111, the display disposed closer to the viewer 100 is referred to as a “second display 111a”, while the display closer to the light source 101 is referred to as a “third display 111b”.

In the example illustrated in FIG. 4, in between the second display 111a and the third display 111b, a fourth optical element 121 is disposed for the purpose reducing the occurrence of moire. The fourth optical element 121 is a lenticular lens in which lenses (cylindrical lenses) extending in the direction inclined at an angle other than 0° with respect to the horizontal or vertical direction of the third display 111b are arranged in a periodic manner.

Moreover, in the example illustrated in FIG. 4, in between the second display 111a and the fourth optical element 121, a fifth optical element 132 is disposed for the purpose of correcting the direction of polarization disturbed by the fourth optical element 121. Thus, of the light transmitted from the fourth optical element 121, the fifth optical element 132 transmits the light having a third direction polarization to the second display 111a. In an identical manner to the second optical element 130 described above, the fifth optical element 132 can be configured with, for example, any one of a linear-polarization plate, an elliptic-polarization plate, and a circular-polarization plate.

For example, in order to ensure that the first direction of polarization (i.e., the direction of polarization passing through the second optical element 130) and the third direction of polarization are identical, the direction of absorption axis (or the direction of transmission axis) of each of the second optical element 130 and the fifth optical element 132 can be set parallel to each other. However, if the direction of polarization changes because of an optical element such as a half-wavelength plate disposed in between the fifth optical element 132 and the second optical element 130; then it is desirable to set the direction of absorption axis (or the direction of transmission axis) in such a way that, of the light transmitted from the fifth optical element 132, the light passing through the second optical element 130 is maximized. In essence, the first direction of polarization as well as the third direction of polarization is set according to the polarization property of the optical element present in between the fifth optical element 132 and the second optical element 130.

Meanwhile, instead of using the above-mentioned configuration in which a lenticular lens for reducing the occurrence of moire and an optical element for correcting the direction of polarization disturbed by the lenticular lens are disposed in between each pair of adjacent displays included in the display group 111; the configuration can be such that, for example, a lenticular lens for reducing the occurrence of moire and an optical element for correcting the direction of polarization disturbed by the lenticular lens are not disposed in between some pairs of adjacent displays from among a plurality of pairs of adjacent displays included in the display group 111.

In essence, the configuration can include the fourth optical element, which is provided between the second display and the third display and in which lenses extending in the direction inclined at an angle other than 0° with respect to the horizontal or vertical direction of the third display are arranged in a periodic manner; and can include the fifth optical element, which is provided between the second display and the fourth display and which, of the light transmitted from the fourth optical element, transmits the light having the third direction of polarization to the second display.

### (4) Fourth Modification Example

In the embodiment described above, for example, the configuration can be such that the second optical element 130 doubles as the polarization plate 211 (see FIG. 2) at the lower surface of the liquid crystal panel constituting the first display 110. In such a configuration, the polarization plate 211 becomes redundant, thereby enabling achieving reduction in the number of components. As a result, the manufacturing cost can also be reduced.

### (5) Fifth Modification Example

For example, in the configuration illustrated in FIG. 3, the liquid crystal display constituting the first display 110 as well as constituting each of a plurality of display included in the display group 111 may not have the polarization plates (211 and 212) illustrated in FIG. 2. In the following explanation, the first display is referred to as a “first display 140”, the display group is referred to as a “display group 150”, a plurality of displays included in the display group is referred to as “displays 141”, the display is referred to as a “display 13”, and the stereoscopic image display is referred to as a “stereoscopic image display 4”.

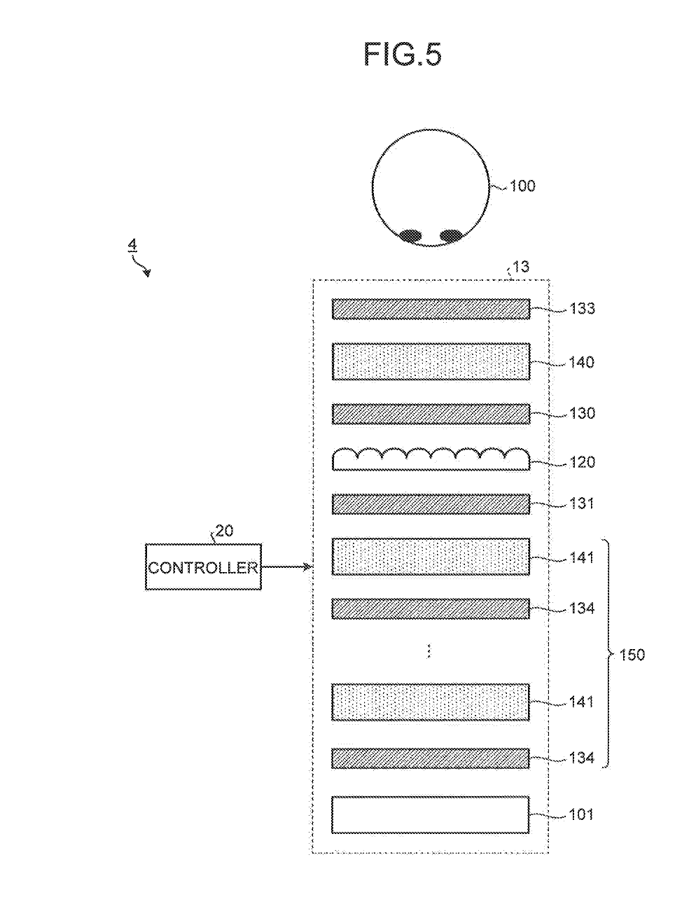

FIG. 5 is a diagram illustrating the stereoscopic image display 4 according to the fifth modification example. As illustrated in FIG. 5, the second optical element 130 doubles as a polarization plate at the lower surface of the first display 140 (i.e., doubles as the polarization plate 211 illustrated in FIG. 2). Moreover, in the example illustrated in FIG. 5, on the other side of the first display 140 with reference to the second optical element 130 (i.e., on the side of the viewer 100 with reference to the first display 140), a polarization plate 133 is disposed that functions as the polarization plate at the upper surface of the first display 140 (i.e., functions as the polarization plate 212 illustrated in FIG. 2).

Furthermore, in the example illustrated in FIG. 5, the third optical element 131 doubles as a polarization plate at the upper surface of the display 141 that is closest to the viewer 100 (i.e., the second display) from among the displays 141 included in the display group 150. Moreover, in the example illustrated in FIG. 5, the display group 150 is configured by alternately disposing the displays 141 and polarization plates 134, each of which functions either as the polarization plate 211 or the polarization plate 212 illustrated in FIG. 2. In such a configuration, a single polarization plate 134 present in between two displays 141 not only functions as the polarization plate at the lower surface of one display 141 but also functions as the polarization plate at the upper surface of the other display 141. That enables achieving reduction in the number of components. As a result, the manufacturing cost can also be reduced.

Meanwhile, the embodiment described above can be combined with the modification examples in an arbitrary manner. Moreover, the modification examples can also be combined with each other in an arbitrary manner. For example, it is possible to combine the second modification example with the third modification example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image display comprising:
a first display that includes pixels arranged therein;
a second display that includes pixels arranged in horizontal and vertical directions and that is disposed on the first display;
a first optical element that is provided between the first display and the second display, and includes lenses extending in a direction inclined with respect to the horizontal or vertical direction of the second display; and
a second optical element that is provided between the first display and the first optical element, and that transmits a light polarized in first direction of a light transmitted from the first optical element.

2. The display according to claim 1, wherein the first optical element includes lenticular lenses.

3. The display according to claim 1, wherein the first display is closer to a position to be watched than the second display.

4. The display according to claim 3, further comprising a third display that is disposed on the first display or the second display.

5. The display according to claim 1, further comprising a third optical element that is provided between the first optical element and the second display, and that, of a light transmitted from the second display, transmits a light having a second direction to the first optical element.

6. The display according to claim 5, wherein the first direction is same as the second direction.

7. The display according to claim 5, wherein the first direction and the second direction are set according to polarization property of the first optical element.

8. The display according to claim 7, wherein each of the first direction and the second direction is a direction in which, of a light transmitted from the third optical element, a light passing through the second optical element via the first optical element is maximized.

9. The display according to claim 4, further comprising:
a fourth optical element that is provided between the second display and the third display, and includes lenses extending in a direction inclined with respect to the horizontal or vertical direction of the third display are arranged in a periodic manner; and
a fifth optical element that is provided between the second display and the fourth optical element, and that, of a light transmitted from the fourth optical element, transmits a light having a third direction of polarization to the second display.

10. The display according to claim 1, wherein the second optical element is either one of a linear-polarization plate, an elliptic-polarization plate, and a circular-polarization plate.

11. The display according to claim 1, wherein the second display transmits light to first optical element.

12. The display according to claim 11, wherein the second display is a transmissive display.

13. The display according to claim 11, wherein
each of the first display and the second display is a liquid crystal display, and
the second display is disposed on a light source.

14. The display according to claim 1, wherein the second optical element rotates polarization light in a longitudinal direction of the lens.

15. The display according to claim 14, wherein the second optical element is an elliptic-polarization plate.

16. The display according to claim 1, wherein the first direction is a direction in which, a light passing through the second optical element toward the first display is maximized.
